(19) United States
(12) Patent Application Publication
(10) Pub. No.: US 2004/0136653 A1
(43) Pub. Date: Jul. 15, 2004

(54) Grating device, method of fabricating the same and optical communication system including the same

(76) Inventors: Kiyotaka Murashima, Yokohama-shi (JP); Ken Hashimoto, Yokohama-shi (JP); Toshikazu Shibata, Osaka (JP); Akira Inoue, Yokohama-shi (JP)

Correspondence Address: MCDERMOTT, WILL & EMERY, 600 13th Street, N.W., Washington, DC, 20005-3096, US

(21) Appl. No.: 10/686,783

(22) Filed: Oct. 17, 2003

(30) Foreign Application Priority Data
Oct. 17, 2002 (JP) P2002-303453

(51) Int. Cl. G02B 6/34

(52) U.S. Cl. 385/37

(57) ABSTRACT

The present invention relates a method of easily fabricating a grating device having a desired reflection characteristic, and the like. In this fabrication method, the phase grating mask is relatively shifted along the longitudinal direction of the optical waveguide by a distance of one half of the grating period of the phase grating mask during the refractive index change inducing light is irradiated on the optical waveguide through the phase grating mask.

### BACKGROUND OF THE INVENTION

1. Field of the Invention

This invention relates to an optical waveguide type grating device comprising an optical waveguide and a grating formed in the optical waveguide along a longitudinal direction thereof, a method of fabricating the same, and an optical communication system including the same.

2. Related Background Art

Optical waveguide type grating devices are optical devices each which includes an optical waveguide such as optical fiber, for example, and in which a grating due to refractive index modulation is formed along a longitudinal direction of the optical waveguide.

Among thus grating devices, the grating device, which includes a Bragg grating whose grating period is comparatively short, can selectively reflect a light component with a wavelength that satisfies a Bragg condition among propagation light components that reach the grating, and therefore can be used as an optical filter in an optical communication system.

The grating device including the above-mentioned Bragg grating can be fabricated by phase grating method. The phase grating method is described in, for example, (Document 1) K. O. Hill, et al., “Bragg gratings fabricated in monomode photosensitive optical fiber by UV exposure through a phase mask”, Appl. Phys. Lett., Vol.62, No.10, pp.1035-1037 (1993), and (Document 2) A. Inoue, et al., “Optimization of Fiber Bragg Grating for Dense WDM Transmission System”, IEICE Trans. Electron., Vol.E81-C, No.8, pp.1209-1218.

Namely, an optical waveguide, which has a photosensitivity with respect to a light component in a predetermined wavelength band, is prepared, and a phase grating mask, in which a phase grating is formed on one surface of a transparent plane plate, is prepared. While this phase grating mask is disposed at the side of the optical waveguide, the refractive index change inducing light is irradiated on the optical waveguide. At this time, the refractive index change inducing light incident on the phase grating mask is diffracted by the phase grating mask, whereby +1st order diffracted light and −1st order diffracted light occur, and then interference fringes of these +1st order diffracted light and −1st order diffracted light are formed. And, in the optical waveguide having the photosensitivity, a spatial refractive index modulation occurs in accordance with a spatial intensity modulation of the refractive index change inducing light corresponding to the interference fringes, whereby a grating is formed. Thus, an optical waveguide type grating device can be obtained.

### SUMMARY OF THE INVENTION

As a result of having studied a conventional grating device fabricated as above, the inventions have discovered the following problems. Namely, a conventional grating device can selectively reflect propagation light with a wavelength λ_{B} (=2 Nd) that corresponds to an average effective refractive index N in a grating and a grating period d. However, there is a case that the conventional grating device not only selectively reflects the propagation light with the wavelength λ_{B} but also reflects the propagation light with a wavelength other than λ_{B}. In this case, there is a problem that the application to an optical ADM (Add Drop Multiplexer) becomes difficult because this grating device will have a non-intentional reflection characteristic.

The present invention has been accomplished in order to solve the problem described above, and an object of the invention is to provide a grating device having a desired reflection characteristic, a method of easily fabricating the grating device, and an optical communication system including the grating device.

A method of fabricating a grating device according to the present invention forms a grating due to a refractive index modulation along a longitudinal direction of an optical waveguide by irradiating a refractive index change inducing light on an optical waveguide through a phase grating mask positioned at the side of the optical waveguide.

In particular, the fabrication method comprises a first step of irradiating the refractive index change inducing light on the optical waveguide through the phase grating mask positioned at the side of the optical waveguide so as to satisfy a first relative arrangement relation together with the optical waveguide, and a second step of irradiating the refractive index change inducing light on the optical waveguide through the phase grating mask which is relatively shifted with respect to the optical waveguide so as to satisfy a second relative arrangement relation different from the first relative arrangement relation. In other words, in the second step, prior to the irradiation of the refractive index change inducing light, the phase grating mask is shifted along the longitudinal direction of the optical waveguide by a distance of one half of grating period M (M: odd number) of the phase grating mask.

According to the present invention, in the first step, the optical waveguide and the phase grating mask are arranged so as to satisfy the first relative arrangement relation. On the other hand, in the second step, in order the optical waveguide and the phase grating mask to be positioned so as to satisfy the second relative arrangement relation, the phase grating mask is shifted along the longitudinal direction of the optical waveguide by the distance of one half of the grating period M (M: odd number) of the phase grating mask. Furthermore, in the first step, the refractive index change inducing light is irradiated on the optical waveguide through the phase grating mask under the first relative arrangement relation, and, in the second step, the refractive index change inducing light is irradiated on the optical waveguide through the phase grating mask under the second relative arrangement relation. In this way, the phase grating is shifted by the distance of one half of the grating period M of the phase grating mask on the first relative arrangement relation and the second relative arrangement relation. Thereby, even if zero order light occurs from the phase grating mask, modulation components of unnecessary period are removed or reduced in the phase grating mask of the present invention in which a grating due to the refractive index modulation is formed. As a result, the reflection of the propagation light with a wavelength other than the Bragg wavelength λ_{B}, and the grating device having a desired reflection characteristic can be obtained.

In the fabrication method of grating device according to the present invention, an irradiation amount of the refractive index change inducing light in the first step is approximately equal to that of the refractive index change inducing light in the second step. Also, it is preferable that the first step and the second step are alternately repeated two or more times. At this time, the repetition number of times of the first step may be equal to that of second step. In addition, the irradiation amount of the refractive index change inducing light in the first step may be changed or not be changed every time the first step is repeated. Similarly, the irradiation amount of the refractive index change inducing light in the second step may be changed or not be changed every time the second step is repeated.

A grating device according to the present invention is an optical device fabricated by the above fabrication method (a fabrication method according to the present invention), and comprises an optical waveguide and a grating due to refractive modulation formed along the longitudinal direction of the optical waveguide. In the grating device, modulation components of unnecessary period are removed or reduced. As a result, a reflection of propagation light including light with a wavelength of other than the Bragg wavelength λ_{B}, and a desired reflection characteristic can be achieved.

Furthermore, an optical communication system according to the present invention, comprises an optical transmission line through which signal light having a plurality of channels with different wavelengths, and a grating device (grating device according to the present invention) having the above-mentioned structure. In the optical communication system, the signal light is treated by the above grating device, and thereby a high quality signal transmission ban be realized.

According to the present invention, between the irradiation of the refractive index change inducing light in the first step and the irradiation of the refractive index change inducing light in the second step, the phase grating mask is shifted along the longitudinal direction of the optical waveguide by the distance of one half of the grating period M (M: odd number) of the phase grating mask. Thus, even if zero order light occurs from the phase grating mask, modulation components of undesired period can be removed or reduced in thus obtained grating device. As a result, a reflection of propagation light with a wavelength other than the Bragg wavelength λ_{B} is restrained, and a desired reflection characteristic can be achieved.

The present invention will be more fully understood from the detailed description given hereinbelow and the accompanying drawings, which are given by way of illustration only and are not to be considered as limiting the present invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will be apparent to those skilled in the art from this detailed description.

### BRIEF DESCRIPTION OF THE DRAWINGS

FIGS. 1A and 1B are views for respectively explaining the construction and the fabrication method of the grating device according to the present invention;

FIGS. 2A and 2B are views for explaining the fabrication method of the grating device according to the present invention ever step;

FIGS. 3A to 3C are views showing the optical characteristics of an optical fiber applied to a sample of the grating device according to the present invention when the refractive index change inducing light with a beam width of 0.2 mm is irradiated;

FIGS. 4A to 4C are views showing the optical characteristics of the grating device obtained by the fabrication method of grating device according to the present invention;

FIGS. 5A to 5C are views showing the optical characteristics of the optical fiber applied to the grating device as a comparative example when the refractive index change inducing light with a beam width of 0.2 mm is irradiated;

FIGS. 6A to 6C are views showing the optical characteristics of the grating device as the comparative example; and

FIG. 7 is a view showing the construction of an optical communication system according to the present invention.

### DETAILED DESCRIPTION OF THE PREFERRED EMBODIMENTS

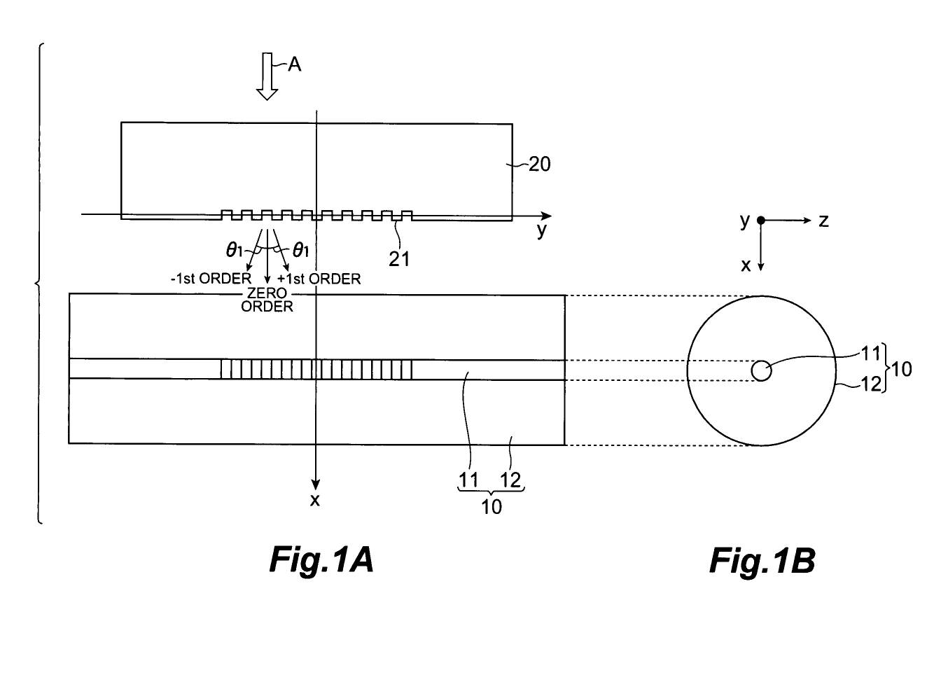

Each of embodiments of the grating device, the fabrication method, and the optical communication system according to the present invention will be described below in detail with reference to FIGS. 1A-6C and 7. The same reference symbols will denote the same portions throughout the description of the drawings, without redundant description thereof.

FIGS. 1A and 1B are views for respectively explaining the construction of the fabrication method of a grating device according to the present invention. A xyz-rectangular coordinate system is shown in this figure for convenience of explanation. A y-axis of the xyz-rectangular coordinate system is in parallel to an optical axis of the optical fiber 10. An origin of the xyz-rectangular coordinate system is located at a center of the surface 21 on which a phase grating of the phase grating mask 20 is formed. FIG. 1A shows cross-sectional structures of the phase grating mask 20 and the optical fiber 10 along the x-y plane, and FIG. 1B shows a cross-sectional structure of the optical fiber 10 along the x-z plane.

The optical fiber 10 is an optical waveguide mainly composed of silica glass, and comprises the core region 11 extending along the optical axis, and the cladding region 12 surrounding the outer periphery of the core region 11.

The core region 11 is doped with GeO₂ as a refractive index riser. In addition, this GeO₂ functions as photosensitive material. In other words, the refractive index of the core region 11 comprised of silica glass doped with GeO₂ raises in accordance with the irradiation amount of the refractive index change inducing light (for example, ultraviolet laser beam of the wavelength 248 nm outputted from KrF excimer laser).

The phase grating mask 20 comprises a transparent plane plate, and a phase grating formed on one surface 21 of the transparent plane plate. And, the phase grating mask 20 is arranged such that the phase grating surface 21 faces the side of the optical fiber 10. At this time, the optical axis of the optical fiber 10 is in parallel to the y-axis, the phase grating surface 21 is in parallel to the y-z plane, and the grating direction of the phase grating surface 21 is in parallel to the z-axis.

The refractive index change inducing light A is irradiated on the optical fiber 10 through the phase grating mask 20. Also, the irradiation position is repeatedly scanned along the longitudinal direction of the optical fiber 10 over the region that the refractive index modulation is formed. At this time, when the refractive index change inducing light A incident on the phase grating mask 20 is diffracted by the phase grating on the phase grating surface 21, +1st order diffracted light and −1st order diffracted light occur, and then interference fringes of these +1st order diffracted light and −1st order diffracted light are formed. And, in accordance with the spatial intensity modulation of the refractive index change inducing light corresponding to this interference fringes, the grating due to the spatial refractive index modulation is formed in the core region 11 of the optical fiber 10 having a photosensitivity. The grating device according to the present invention can be obtained by multiple irradiation of such refractive index change inducing light A.

The intensity distribution I₁(y) of the refractive index change inducing light A due to the interference of +1st order diffracted light and −1st order diffracted light is expressed in the following formula (1).

I₁(y)=|A₊₁exp{−i(kx cos θ₊₁+ky sin θ₊₁)}+A₋₁exp{−i(kx cos θ₋₁−ky sin θ₋₁)}|² (1)

Where, k is the number of wavelengths, A₊₁ is an amplitude of the +1st order diffracted light , A₋₁ is an amplitude of the −1st order diffracted light, θ₊₁ is a diffraction angle of the +1st order diffracted light, and θ₋₁ is a diffraction angle of the −1st order diffracted light. In addition, a time factor is omitted in the right side of this equation. Further, as assuming that the amplitudes of the +1st order diffracted light and the −1st order diffracted light are equal to each other, and that the diffraction angles of the +1st order diffracted light and the −1st order diffracted light are equal to each other, the following formulas (2A) and (2B) can be materialized.

A₊₁32 A₋₁=A₁ (2a)

θ₊₁=θ₋₁=θ₁ (2b)

At this time, the above formula (1) can be expressed in the following formula (3).

$$\begin{matrix}{I}_{1} ( y ) = {\vert {A}_{1} \vert}^{2} {\vert exp \{ - ⅈ k x cos {θ}_{1} \} \vert}^{2} {\vert exp ( - ⅈ k y sin {θ}_{1} ) + exp ( ⅈ k y sin {θ}_{1} ) \vert}^{2} \\ = 4 {\vert {A}_{1} \vert}^{2} {cos}^{2} ( {ky sinθ}_{1} ) \\ = 2 {\vert {A}_{1} \vert}^{2} \{ 1 + cos ( 2 {ky sin θ}_{1} ) \}\end{matrix} \qquad ( 3 )$$

The intensity distribution I₁(y) expressed in this formula (3) is a periodic function regarding to the variable y. When assuming a period of the intensity distribution I₁(y) as d and a period of the phase grating of the phase grating mask 20 as Λ, the relationship of the following formula (4) can be consists.

$$2 {k sin θ}_{1} = \frac{2 π}{d} = \frac{2 π}{Λ / 2} \qquad ( 4 )$$

The period d (a period of intensity distribution I₁(y)) of the grating to be formed in the optical fiber 10 becomes one half of the period Λ of the phase grating of the phase grating mask 20. In addition, the grating in the optical fiber 10 is formed by the ±1st order diffracted lights each diffracting with the diffraction angle θ₁ expressed in the following formula (5).

$${sin θ}_{1} = \frac{π}{kd} = \frac{2 π}{k Λ} \qquad ( 5 )$$

To this place, the formation of the grating in the optical fiber 10 due to the interference of ±1st order diffracted lights has been explained. However, in fact, the phase grating mask 20 emits not only zero order light but also ±1st order diffracted lights. It is extremely difficult to make the power of zero order light emitted from the phase grating mask 20 be zero in reality.

Therefore, the interference of the ±1st order diffracted lights and the zero order light should be considered.

In this case, the intensity distribution I₂(y) of the refractive index change inducing light A in the interference fringes (y) is expressed in the following formula (6).

$$\begin{matrix}{I}_{2} ( y ) = \vert {A}_{0} exp ( - ⅈ kx ) + {A}_{1} exp \{ - ⅈ ( kx cos {θ}_{1} + {ky sin θ}_{1} ) \} + \\ { {A}_{1} exp \{ - ⅈ ( kx cos {θ}_{1} - {ky sin θ}_{1} ) \} \vert}^{2} \\ = {\vert {A}_{0} exp ( - ⅈ kx ) + 2 {A}_{1} exp ( - ⅈ kx cos {θ}_{1} ) cos ( {ky sin θ}_{1} ) \vert}^{2} \\ {\vert {A}_{0} \vert}^{2} + 2 {\vert {A}_{1} \vert}^{2} \{ 1 + cos ( 2 {ky sin θ}_{1} ) \} + \\ 4 {A}_{0} {A}_{1} cos \{ kx ( 1 - {cos θ}_{1} ) \} cos ( {ky sin θ}_{1} )\end{matrix} \qquad ( 6 )$$

The intensity distribution I₂(y) expressed in this formula (6) is also a periodic function regarding to the variable y. Here, the first term in the right side is a constant. The second term in the right side is a function of period d as the same of the right side of the formula (3), and is an interference component of the +1st order diffracted light and the −1st order diffracted light. However, the third term in the right side is a function of period 2d, and is an interference of the ±1st order diffracted lights and the zero order light. In this way, when the zero order light exists, the grating due to the refractive index modulation formed in the optical fiber 10 includes a modulation component of undesired period 2d together with a desired modulation component of period d. Since the modulation component of undesired period 2d is included, thus grating device can be considered to reflect the propagation light with a wavelength other than the Bragg wavelength λ_{B}.

Therefore, the fabrication method of grating device according to the present invention fabricates a grating device by separating a first step and a second step as follows in order to remove the modulation component of undesired period 2d. Namely, in the first step, the positions of the optical fiber 10 and the phase grating mask 20 is set so as to satisfy a first relative arrangement relation, and a refractive index change inducing light A is irradiated on the optical fiber 10 through the phase grating mask 20. Subsequently, in the second step, the positions of the optical fiber 10 and the phase grating mask 20 is set so as to satisfy a second relative arrangement relation different from the first relative arrangement relation, prior to the irradiation of the refractive index change inducing light A. In other words, the phase grating mask 20 is shifted along a longitudinal direction of the optical fiber 10 by a distance (Λ/2) of one half of the grating period Λ of the phase grating mask 20. And, through the phase grating mask 20 whose relative position with respect to the optical fiber is shifted, the refractive index change inducing light A is irradiated on the optical fiber 10.

The difference between the irradiation amount of the refractive index change inducing light A in the first step and the irradiation amount of the refractive index change inducing light A in the second step is preferably small, further preferably equal to each other. In this case, the time average I₃(y) in the intensity distribution of the refractive index change inducing light A due to the interference fringes is expressed in the following formula (7) by using the intensity distribution I₂(y).

I₃(y)={I₂(y)+I₂(y+Λ/2)}/2 (7)

Furthermore, the refractive index modulation formed in the optical fiber 10 corresponds to the intensity distribution I₃(y) of the following formula (8).

I₃(y)=|A₀|²+2|A₁|²{1+cos(2ky sin θ₁)} (8)

This refractive index modulation includes the modulation component of desired period d, but does not include the modulation component of undesired period 2d.

As described above, in the fabrication method of grating device according to the present invention, the relative positions of the optical fiber 10 and the phase grating mask 20 is shifted along the longitudinal direction of the optical fiber 10 by the distance (Λ/2) between the first relative arrangement relation in the first step and the second relative arrangement relation in the second step. Thus, even if zero order light occurs from the phase grating mask 20, the modulation component of undesired period 2d is removed or reduced in the grating device according to the present invention in which a grating die to the refractive index modulation. As a result, a reflection wavelength other than the Bragg wavelength λ_{B} is restrained, and the grating device having a desired reflection characteristic can be obtained.

Furthermore, as considering ±2nd order diffracted lights (diffraction angle θ₂=2θ₁), the modulation component due to the interference of the +2nd order diffracted lights and the zero order light is expressed by a cosine function which the product of the coefficient and the variable y expressed in the following formula (9) is set to an argument. Therefore, the modulation component becomes a periodic function of d/(1−(π/kd)²)^{1/2}.

$${k sin θ}_{2} = k sin 2 {θ}_{1} = 2 k {sin θ}_{1} cos {θ}_{1} = \frac{2 π}{d} \sqrt{1 - {( \frac{π}{kd} )}^{2}} \qquad ( 9 )$$

This modulation component can also become a factor reflecting the propagation light with the wavelength other than the Bragg wavelength λ_{B}. However, as the grating due to the refractive index modulation is formed by the above-mentioned first and second steps, the modulation component of undesired period is removed or reduced in the grating device. In addition, a reflection of the propagation light with the wavelength other than the Bragg wavelength λ_{B} is restrained, and a desired reflection characteristic can be realized.

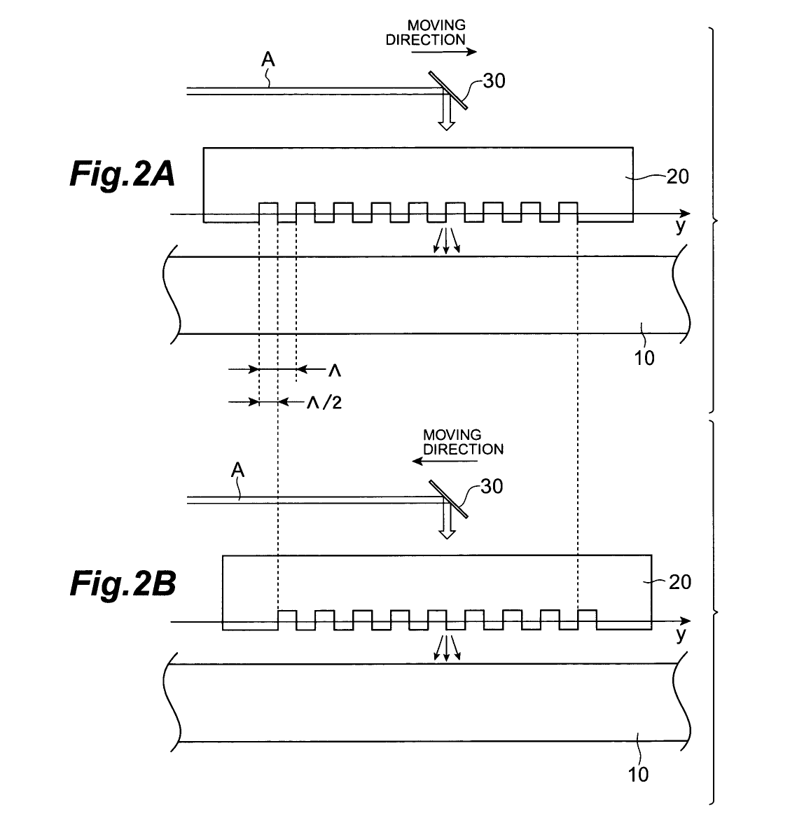

FIGS. 2A and 2B are views for explaining the fabrication method of grating device according to the present invention every step. FIG. 2A shows the first relative arrangement relation between the optical fiber 10 and the phase grating mask 20 in the first step, ad FIG. 2B shows the second relative arrangement relation between the optical fiber 10 and the phase grating mask 20 in the second step. As shown in these FIGS. 2A and 2B, the positions of the optical fiber 10 and the phase grating mask 20 is relatively shifted along the longitudinal direction of the optical fiber 10 between the first arrangement relation in the first step and the second relative arrangement relation in the second step. And, under the first arrangement relation in the first step, the refractive index change inducing light A is irradiated on the optical fiber 10 through the phase grating mask 20. Subsequently, under the second relative arrangement relation, the refractive index change inducing light A is irradiated on the optical fiber 10 through the phase grating mask 20.

The irradiation amount of the refractive index change inducing light A in the first step is preferably equal to that of the refractive index change inducing light A in the second step. Also, as assuming the power of the refractive index change inducing light A is constant, the irradiation time of the refractive index change inducing light A in the first step is preferably equal to that of the refractive index change inducing light A in the second step.

The first step and the second step are respectively performed once, but may be alternately repeated. When the first step and the second step are alternately repeated, the number of times that the first step is repeated is preferably equal to the number of times that the second step is repeated. At this time, the irradiation amount of the refractive index change inducing light A in the first step may not be changed or may be changed every time the first step is repeated. In addition, the irradiation amount of the refractive index change inducing light A in the second step may not be changed or may be changed every time the second step is repeated.

For example, in the case that the mirror 30 is repeatedly scanned the region where a refractive index modulation should be formed along the longitudinal direction of the optical fiber 10, as shown in FIG. 2A, the positions of the optical fiber 10 and the phase grating mask 20 are set so as to satisfy the first arrangement relation in the term (first step) during the mirror 30 moves in a +y direction, and as shown in FIG. 2B, the positions are set so as to satisfy the second relative arrangement relation (second step) during the mirror 30 moves in a −y direction. When the power of the refractive index change inducing light A is constant and the mirror 30 reciprocates by a constant speed, the irradiation amount of the refractive index change inducing light A irradiated on the optical fiber 10 in each step becomes equal every time each of the first step and the second step is repeated. Or, during the mirrors 30 moves in the +y direction, the first relative arrangement relation and the second relative arrangement relation may appear more than once.

Next, as a grating device according to the present invention, optical characteristics of a sample fabricated by the above-mentioned fabrication method to cancel an influence of zero order light will be explained together with a comparative example.

This sample can be obtained by preparing an optical fiber as an optical waveguide, and sequentially carrying out the irradiation of the first step (see FIG. 2A) and the irradiation of the second step (see FIG. 2B), with respect to the prepared optical fiber. A phase period of the phase grating mask is set to 1.06 μm to obtain a grating with a Bragg period 530 nm, and a distance between this phase grating mask and the core region of the prepared optical fiber is set to 162.5 μm.

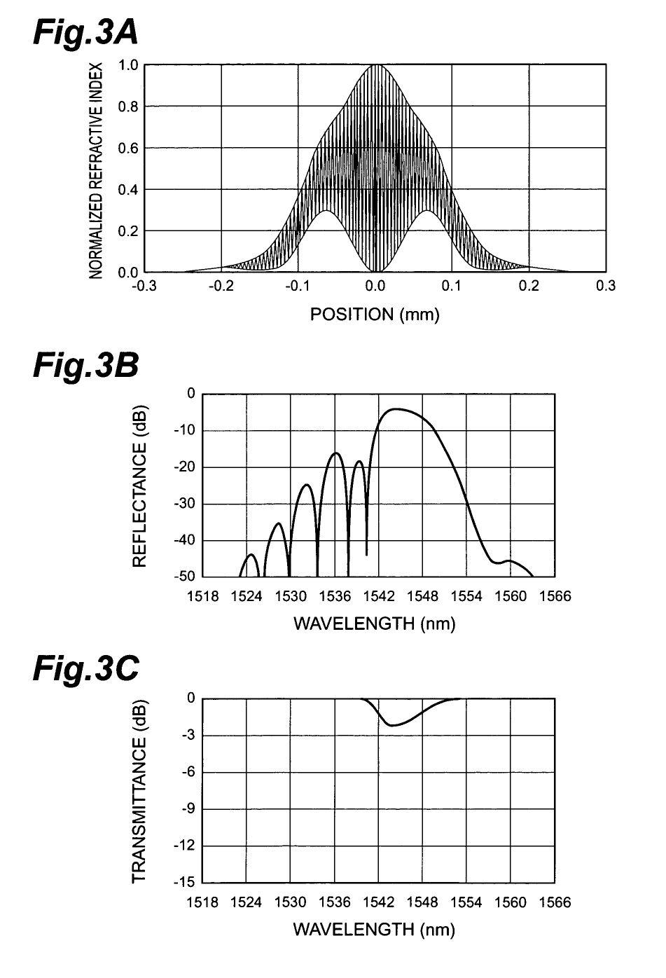

FIG. 3A shows a normalized refractive index at the time of irradiating a refractive index change inducing light with a beam width 0.2 mm (a width such that a beam power with respect to a peak becomes 1/e) on the prepared optical fiber. In FIG. 3A, the abscissa axis indicates a position in a longitudinal direction of the optical fiber, and a vertical axis indicates a normalized refractive index when a maximum refractive index is set to 1. In addition, FIGS. 3B and 3C shows a reflection spectrum and a transmission spectrum of the optical fiber applied to this sample, these spectra being computed while assuming a maximum of a refractive index change Δnₘₐₓ as 8.0×10⁻³.

First, As shown in FIG. 2A, the irradiation of the first step is carried out to the above optical fiber. Namely, by moving the mirror in the arrow direction in FIG. 2A, the beam irradiated on the prepared optical fiber is moved by 10.6 mm along the optical fiber (first step). Subsequently, the phase grating mask arranged at the side of the optical fiber is shifted by 0.53 μm (530 nm), and the irradiation of the second step is carried out. Namely, by moving the mirror in the arrow direction in FIG. 2B, the beam irradiated on the prepared optical fiber is moved by 10.6 mm along the optical fiber (second step). After the above-mentioned fabrication process, a sample of the grating device according to the present invention can be obtained.

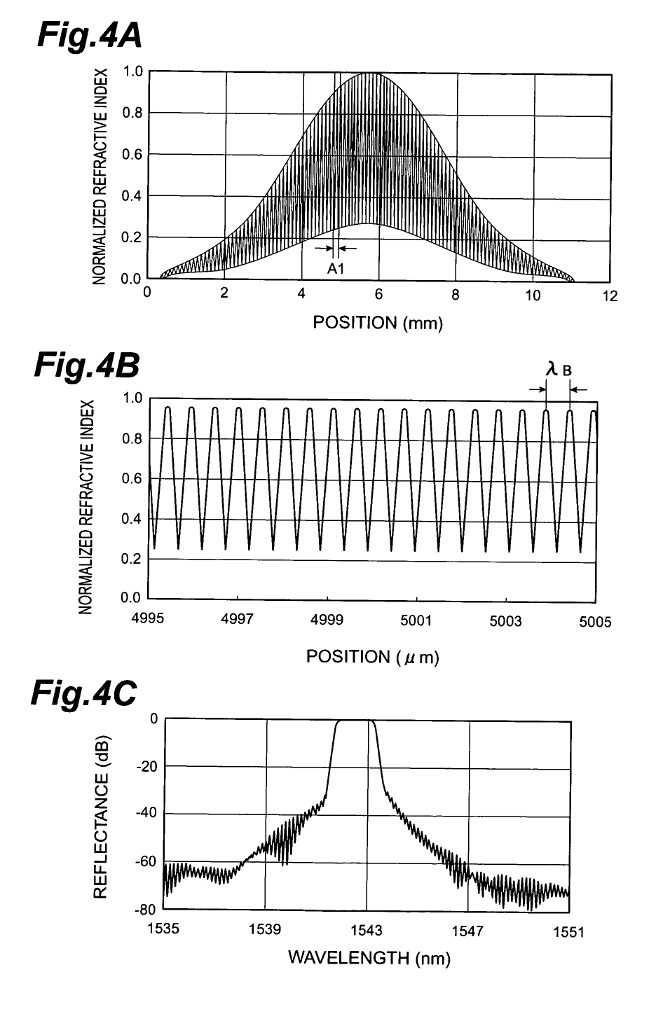

FIG. 4A shows a normalized refractive index of the sample obtained by the above-mentioned fabrication process. Also, FIGS. 4B is an enlarged view of the region A1 of FIG. 4A, and it can be seen that a period of the grating formed in this sample includes the Bragg wavelength λ_{B} only. Furthermore, FIG. 4C shows a reflection spectrum of the obtained sample, and this spectrum is computed while assuming the maximum of the refractive index change Δnₘₐₓ as 2.0×10⁻³.

On the other hand, a grating device of a comparative example can be obtained by preparing an optical fiber as an optical waveguide, and simple irradiating the refractive index change inducing light on this optical fiber. A phase period of the phase grating mask is set to 1.06 μm to obtain a grating with a Bragg period 530 nm, and a distance between this phase grating mask and the core region of the prepared optical fiber is set to 162.5 μm.

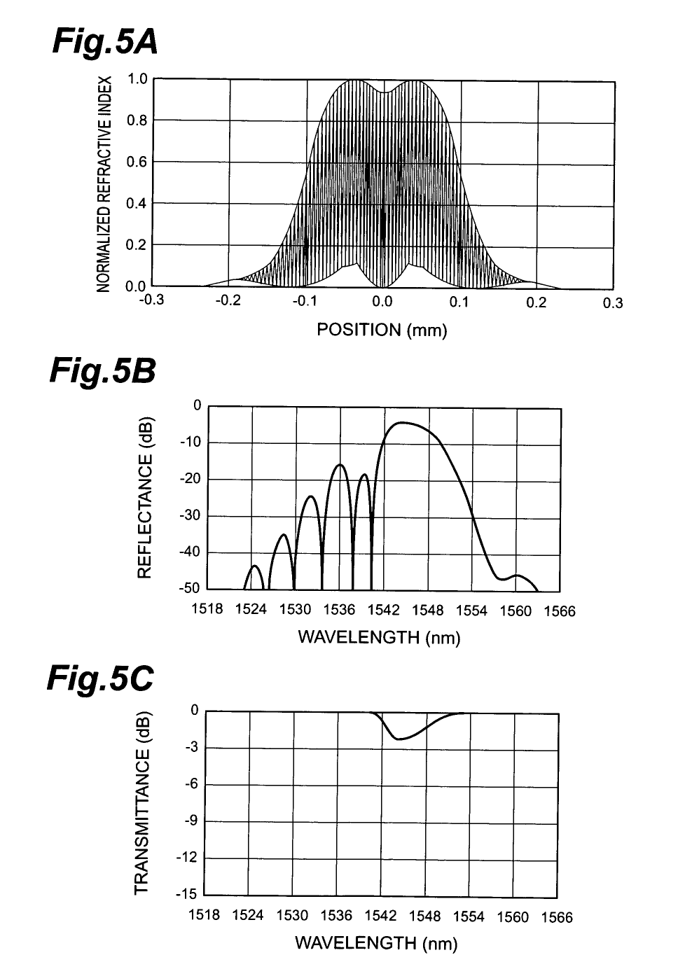

FIG. 5A shows a normalized refractive index at the time of irradiating a refractive index change inducing light with a beam width 0.2 mm (a width such that a beam power with respect to a peak becomes 1/e) on the prepared optical fiber. In FIG. 5A, the abscissa axis indicates a position in a longitudinal direction of the optical fiber, and a vertical axis indicates a normalized refractive index when a maximum refractive index is set to 1. In addition, FIGS. 5B and 5C respectively show a reflection spectrum and a transmission spectrum of the optical fiber applied to this comparative example, these spectra being computed while assuming a maximum of a refractive index change Δnₘₐₓ as 8.0×10⁻³.

First, the irradiation of the refractive index change inducing light is carried out to the optical fiber. Namely, by moving the mirror along the prepared optical fiber, the beam irradiated on the optical fiber is moved by 10.6 mm. Subsequently, by moving the mirror in a reversed direction along the prepared optical fiber, the beam irradiated on the optical fiber is moved by 10.6 mm. After the above-mentioned fabrication process, a comparative example to the grating device according to the present invention can be obtained. In particular, in the fabrication process of this comparative example, the phase grating mask is not moved.

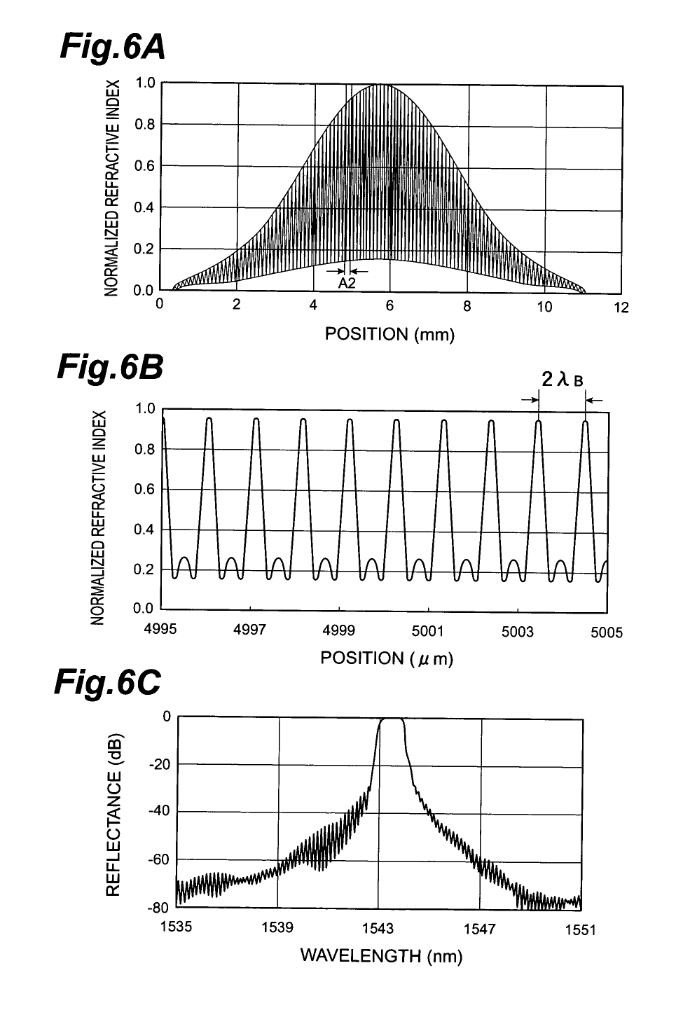

FIG. 6A shows a normalized refractive index of the comparative example obtained by the above-mentioned fabrication process. Also, FIGS. 6B is an enlarged view of the region A2 of FIG. 6A, and it can be seen that a period of twice the Bragg wavelength λ_{B} remarkably appears as a period of the grating formed in this comparative example. Furthermore, FIG. 6C shows a reflection spectrum of the obtained comparative example, and this spectrum is computed while assuming the maximum of the refractive index change Δnₘₐₓ as 2.0×10⁻³.

In the thus fabricated comparative example in which an influence of zero order light is not canceled, as shown in FIG. 6B, a component with twice the Bragg period also contributes to the rise of refractive index, and therefore the grating efficiency of the grating device as an optical filter decreases as compared with the sample in which an influence of zero order light has been canceled. Usually, since the upper limit of the rise of refractive index in an optical fiber is finite, it is clear that the refractive index modulation of the Bragg period only is effective in order to effectively use the rise of refractive index, and further it can be considered that the cancel of zero order light is the most effective to make the refractive index modulation of the Bragg period only be possible.

Actually, as computing each reflection spectrum in FIGS. 4C and 6C, the grating intensity of the grating device of the sample in which the zero order light has been canceled is stronger than that of the grating device of the comparative example, and therefore this matter shows that the fabrication method according to the present invention is effective.

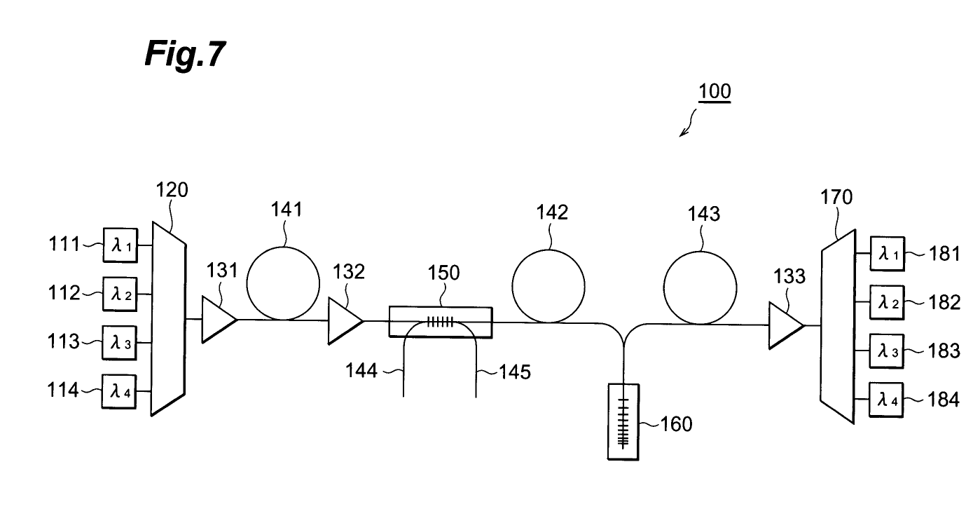

Next, an embodiment of an optical communication system according to the present invention will be explained. FIG. 7 is a view showing the construction of the optical communication system according to the present invention. The optical communication system 100 comprises optical transmitters 111-114, optical multiplexer 120, optical amplifiers 131-133, optical fiber transmission lines 141-145, optical multiplexer/demultiplexer 150, dispersion adjuster 160, optical demultiplexer 170, and optical receivers 181-184.

In this optical communication system 100, the optical transmitter 111 outputs the signal channel with the wavelength λ₁, the optical transmitter 112 outputs the signal channel with the wavelength λ₂, the optical transmitter 113 outputs the signal channel with the wavelength λ₃, and the optical transmitter 114 outputs the signal channel with the wavelength λ₄. And, the signal channels of wavelengths λ₁-λ₄ outputted from these optical transmitters 111-114 are multiplexed by the optical multiplexer 120, and the multiplexed light is sent out to the optical fiber transmission line 141 after being collectively amplified by the optical amplifier 131.

The multiplexed signal light with the wavelegths of λ₁-λ₄, which has propagated through the optical fiber transmission line 141, reaches the optical multiplexer/demultiplexer 150 after being amplified by the optical amplifier 132. Among the signal channels with wavelengths of λ₁-λ₄ reaching the optical multiplexer/demultiplexer 150, the signal channel with the wavelengths of λ₁ is separated from the signal channels with other wavelength of λ₂-λ₄ by the multiplexer/demultiplexer 150, and is sent to the optical fiber transmission line 144. On the other hand, the signal channels with the other wavelengths of λ_{2-λ}₄ are multiplexed to the signal channel with the wavelength of λ₁ reaching through the optical fiber transmission line 145. And, the multiplexed signal light that the signal channels with the wavelengths of λ₁-λ₄ are multiplexed is sent to the optical fiber transmission line 142.

The multiplexed signal light including the wavelengths of λ₁-λ₄ which has propagated through the optical fiber transmission line 142, after being dispersion-adjusted by the dispersion adjuster 160, is further sent to the optical fiber transmission line 143, and reaches the optical amplifier 133. And, the multiplexed signal light reaching the optical amplifier 133 is collectively amplified and demultiplexed by the optical demultiplexer 170 every channel. The signal channel with the wavelength of λ₁ outputted from the optical demultiplexer 170 is received by the optical receiver 181, the signal channel with the wavelength of λ₂ outputted from the optical demultiplexer 170 is received by the optical receiver 182, the signal channel with the wavelength of λ₃ outputted from the optical demultiplexer 170 is received by the optical receiver 183, and the signal channel with the wavelength of λ₄ outputted from the optical demultiplexer 170 is received by the optical receiver 184.

In the optical communication system 100 having the above structure, the grating device (grating device according to the present invention) is used as one component in each of the optical transmitters 111-114, the optical amplifiers 131-133, the optical multiplexer/demultiplexer 150, the dispersion adjuster 160, and the optical demultiplexer 170.

Each of the optical transmitters 111-114 includes a semiconductor emission device and the grating device, and light which has a wavelength equal to the reflection wavelength of the grating device and has a superior monochromatic and stability can be outputted by using the grating device as one reflection surface of an external resonator. Similarly, the grating device can be also applied to the pumping light sources respectively included in the optical amplifiers 131-133. In addition, in the case that the signal light is distributed Raman amplified in the optical fiber transmission lines 141-143, the grating device can be similarly applied to the pumping light source outputting the pumping light for Raman amplification.

In the optical multiplexer/demultiplexer 150, the grating device can be applied as an optical coupling portion of an optical fiber coupler, and can demultiplex or multiplex the signal light with a wavelength equal to the reflection wavelength of the grating device.

The dispersion adjuster 160 includes a grating device whose grating spacing is changed along a longitudinal direction of the transmission line, and light components with different wavelengths are reflected at different positions along the longitudinal direction of the transmission line. By this, the chromatic dispersion of signal light can be adjusted.

The optical demultiplexer 170 includes a star coupler and a plurality of grating devices having reflection wavelengths different from each other, and the signal light with the wavelengths λ₁-λ₄ can be demultiplexed every channel by the grating devices respectively reflecting light components with specific wavelengths among the light components demultiplexed by the star coupler.

As described above, the optical communication system 100 according to the present invention handles the signal light propagating through the optical transmission line by using the above-mentioned grating device, and thereby a high quality signal light transmission can be realized.

The present invention is not limited to the above embodiments, but various modifications is possible for the preset invention. For example, the relation between the first relative arrangement relation and the second relative arrangement relation are not limited to the case that the relative positions of the phase grating mask and the optical waveguide is different by a distance of one half of the grating period of the phase grating mask, and the relative positions of them maybe different by a distance of one half of a general grating period M (M: odd number). In addition, the optical waveguide is not limited to optical fiber, and it may be planar optical waveguide.

According to the present invention, even if the zero order light occurs from the phase grating mask, the modulation components of unnecessary period can be removed or reduced. That is, the grating device according to the present invention can be applied to an optical communication system as an optical device having a desired reflection characteristic.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A method of fabricating a grating device which comprises an optical waveguide and a grating formed in said optical waveguide along a longitudinal direction thereof, comprising:
a first step of irradiating a refractive index change inducing light on said optical waveguide through a phase grating mask positioned at a side of said optical waveguide so as to satisfy a first relative arrangement relation among said optical waveguide; and
a second step of irradiating the refractive index change inducing light on said optical waveguide through said phase grating mask shifted, while said phase grating mask is shifted along the longitudinal direction of said optical waveguide by a distance of one half of a grating period M (M: odd number) of said phase grating mask so as to satisfy a second arrangement relation different from the first arrangement relation among said optical waveguide.

2. A method according to claim 1, wherein an irradiation amount of the refractive index change inducing light in said first step is approximately equal to that of the refractive index change inducing light in said second step.

3. A method according to claim 1, wherein said first step and said second step are alternately repeated two or more times.

4. A method according to claim 3, wherein the number of times that said first step is repeated is equal to the number of times that said second step is repeated.

5. A method according to claim 3, wherein an irradiation amount of the refractive index change inducing light in said first step is not changed every time said first step is repeated, and an irradiation amount of the refractive index change inducing light in said second step is not changed every time said second step is repeated.

6. A method according to claim 3, wherein an irradiation amount of the refractive index change inducing light in said first step is changed every time said first step is repeated, and an irradiation amount of the refractive index change inducing light in said second step is changed every time said second step is repeated.

7. A grating device fabricated by a method according to claim 1, comprising:
an optical waveguide; and
a grating formed in said optical waveguide along a longitudinal direction thereof.

8. An optical communication system, comprising:
an optical transmission line; and
a grating device disposed at a predetermined position of said optical transmission line.
